(19) United States
(12) Patent Application Publication
(10) Pub. No.: US 2010/0185488 A1
(43) Pub. Date: Jul. 22, 2010

(54) METHOD AND SYSTEM FOR POLICY CONTROL IN TELECOMMUNICATIONS SERVICES

(75) Inventors: Joe Hogan, Dublin (IE); Alan McNamee, Dublin (IE)

Correspondence Address: AXIOS LAW GROUP, PLLC, 1525 4TH AVE, STE 800, SEATTLE, WA, 98101-1648, US

(73) Assignee: OPENET RESEARCH LIMITED, Dublin (IE)

(21) Appl. No.: 12/393,751

(22) Filed: Feb. 26, 2009

(30) Foreign Application Priority Data
Jan. 16, 2009 (IE) S2009/0031

(51) Int. Cl. G06Q 30/00; G06Q 40/00; G06Q 10/00; G06Q 50/00; G06F 15/16

(52) U.S. Cl. 705/10; 705/31; 705/30; 707/E17.044

(57) ABSTRACT

This disclosure relates to a method and system for policy control in telecommunications services.

### RELATED REFERENCES

This application claims priority to Irish Application No. S2009/0031 filed Jan. 16, 2009 entitled “A Method and System for Policy Control in Telecommunications Services.” The foregoing application is hereby incorporated by reference in its entirety as if fully set forth herein.

### FIELD

This disclosure relates telecommunications, and more specifically to a method and system for policy control in telecommunications services.

### BACKGROUND

Communication service providers frequently use policy managers to deliver policy controls to their subscribers. The standards body IETF defines policies in RFC3198 as a set of rules for administering, managing and controlling access to network resources.

Traditionally, policy management systems operated at the network level, performing traffic or packet shaping on a particular service type or protocol e.g. P2P, VoIP, VoD, etc. to increase performance, reduce latencies and increase the bandwidth that is available for their subscribers as a group.

Many operators have deployed policy management systems around resource admission control (RAC). The drawback of such approaches is that they lack personalization.

More recently, standards development organizations (SDOs) have defined architectures that enable the personalization of policy enforcement on a per subscriber session basis e.g. 3GPP's policy and charging control architecture. In such implementations, a database connected to the policy manager is queried to determine policy information associated with a particular subscriber, which is subsequently utilized for composing the personalized policy regulations for that subscriber. This approach still has drawbacks as the subscriber related information on which the personalization decisions are based for deducing policies tend to be based on a relatively static subscriber profile repository.

### BRIEF DESCRIPTION OF THE DRAWINGS

Embodiments will now be described, by way of example, with reference to the accompanying drawings, in which:

FIG. 1 illustrates a policy and charging control system according to one embodiment;

FIG. 2 illustrates an access gateway initiated message flow according to another embodiment;

FIG. 3 illustrates a spend trigger notification message flow for a gateway controlled online charged subscriber;

FIG. 4 illustrates a spend trigger notification message flow for a network/service node controlled online charged subscriber;

FIG. 5 illustrates a spend trigger notification message flow for a gateway sourced offline charged subscriber;

FIG. 6 illustrates a spend trigger notification message flow for a network/service node sourced offline charged subscriber;

FIG. 7 illustrates session independent spend trigger notification, instigated by a logical device provided in the charging system; and

FIG. 8 illustrates a session independent spend trigger notification instigated by a spend notification, received from an independent party.

### DESCRIPTION

The present disclosure provides an exemplary method of policy control of a telecommunication service to a subscriber of the telecommunication service, the method operable in a communications network comprising a policy manager in communication with a charging system, the method, in accordance with one embodiment comprising, at the charging system, determining spend information specific to the subscriber and responsive to a stimulus, communicating the spend information to the policy manager, and at the policy manager, obtaining policy rules associated with the subscriber, responsive to obtaining the spend information from the charging system, composing policy regulations based on the policy rules and the spend information, and provisioning the policy regulations to the subscriber.

In one embodiment, said method further comprises at said charging system monitoring a spend counter maintaining account information associated with each subscriber and activating said stimulus in response to a threshold value being met by said spend counter.

In another embodiment, said account information comprises spend data criterion including at least one of total spend per year to date, total spend per month to date, total spend per week to date, total spend per day to date, total spend, spend per billing cycle, and spend per cycle.

Alternatively, said method further comprises at said charging system activating said stimulus in response to a triggered event from one of an access gateway, a subscriber at a terminal, a customer service management system, a business support system and a network or service node.

In another embodiment, the method further comprises at said charging system responsive to a change in the state of a spend counter, updating an entry in a lifecycle representation of a history of activities of associated with the subscriber over a period of time.

In a further embodiment, said spend information comprises at least one of a subscriber identifier, a list of spend counter values, a list of spend counter changes, a subscriber spend lifecycle state and a subscriber spend lifecycle change.

In a still further embodiment, obtaining policy rules associated with the subscriber comprises determining said policy rules from a profile of said subscriber stored in a database connected to said policy manager.

In yet another embodiment, obtaining policy rules associated with the subscriber comprises reconciling default policy rules with preferences obtained from a profile of said subscriber stored in a database connected to said policy manager.

In one embodiment, said profile comprises subscriber policy directives including at least one of: tariff name plan, roaming preferences, network preferences, content filtering, charging class, quality of service attributes, permitted services, and online charging control.

In another embodiment, the method further comprises at the charging system determining a tariff associated with the subscriber based on at least one charging option including per unit rating, set-up rating, tiered rating, tapered rating, allowance rating, time band rating and domain rating.

In a further embodiment, said threshold is a high spend threshold and said spend information comprises an indication to said policy manager to upgrade the policy regulations provisioned to the subscriber.

Alternatively, said threshold is a low spend threshold and said spend information comprises an indication to said policy manager to degrade the policy regulations provisioned to the subscriber.

In a still further embodiment, said upgrade comprises degrading subscriber policy directives including at least one of tariff name plan, roaming preferences, network preferences, content filtering, charging class, quality of service attributes, permitted services, and online charging control.

In yet another embodiment, the method further comprises responsive to a low spend threshold being exceeded, and responsive to determining that said subscriber is a priority customer, including an indication to upgrade the policy regulations provisioned to the subscriber in the spend information to be communicated to the policy manager.

In one embodiment, said priority customers include high spend customers, regular customers, pre-paying customers, good credit history customers, and disgruntled customers.

In another embodiment, the method further comprises updating said policy rules associated with the subscriber based on the composed policy regulations.

In a further embodiment, the method further comprises storing said updated policy rules in a rules database provided in the policy manager.

The present disclosure further provides an exemplary computer implemented policy control system for providing policy control to a subscriber of a telecommunication service, the policy control system comprising a charging system in communication with a policy manager across a network, the charging system comprising a balance manager for determining spend information specific to the subscriber and a spend manager responsive to a stimulus, for communicating the spend information to the policy manager and the policy manager comprising a policy controller for obtaining policy rules associated with the subscriber, responsive to obtaining the spend information from the charging system, composing policy regulations based on the policy rules and the spend information and provisioning the policy regulations to the subscriber.

The present disclosure further provides an exemplary computer program product comprising a computer readable medium storing and recording instructions in machine readable form which when executed in a computer implemented policy control system provided in a communications network are effective to cause a computer implemented policy control system to carry various aspects of various embodiments.

The present disclosure further provides an exemplary method for policy control in a communications network, the method comprising, at a charging system, responsive to a stimulus, triggering a subscriber specific event to a policy manager and at the policy manager, responsive to receipt of the subscriber specific event, composing policy regulations for said subscriber based on information associated with the received event.

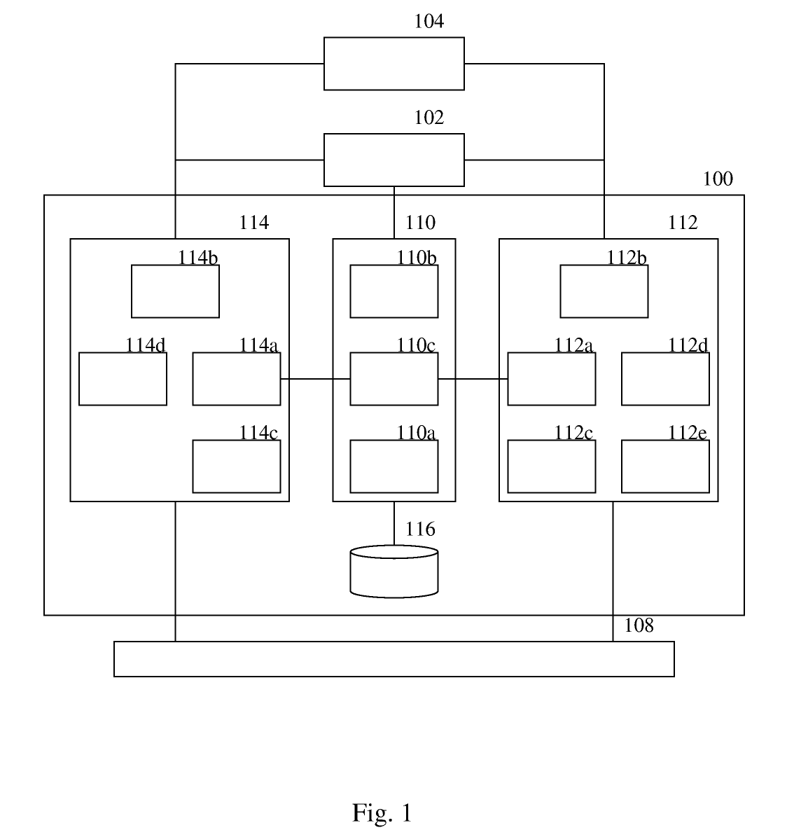

Referring to FIG. 1, there is illustrated a communications network comprising a policy and charging control system 100 according to an embodiment. The system 100 is arranged to allow users at a user terminal to connect and access applications in accordance with subscriber policy and charging controls associated with the user or user terminal.

An access network (not shown) for example, 3GPP, 3GPP2, DOCSIS, TISPAN or WiMAX is provided to connect a user at a terminal having IP enabled equipment, for example, a mobile phone, a PDA, a PC, or a set top box, to the network via an access gateway 102 to access applications provided by an applications server.

As illustrated in FIG. 1, the system 100 comprises a policy manager 110 connected to an online charging system 112, and an offline charging system 114. It will however be appreciated that online charging system 112 can be arranged to operate as both an online charging system and an offline charging system.

In one embodiment, the policy manager 110 is connected to a subscriber database 116. The database 116 is an entity in an operator's charging domain and comprises subscriber related information required to personalize policy regulations. For example, the subscriber related information may comprise subscriber policy directives such as tariff plan name, roaming preferences, network preferences, content filtering, charging class, quality of service (QoS) attributes, permitted services and online charging control.

It will be appreciated, however, that the online charging system 112 and/or the offline charging system 114 may also be connected to the subscriber database 116. Furthermore, in an alternative embodiment, instead of database 116 common to the policy manager, and the online and/or offline charging systems, 112 and 114, respectively, the policy manager 110 is connected to a policy database (not shown) and the online and/or offline charging systems 112, and 114, are connected to a charging database (not shown), the policy database being separate from the charging database. In yet a further embodiment, the online charging system 112 may be connected to a first charging database, and the offline charging system may be connected to a second charging database, separate from the first charging database.

The policy manager 110 provides policy provisioning to the access gateway subscriber sessions. To this end, the manager 110 is arranged to generate and rapidly deploy centralized subscriber centric policy regulations, deliver differentiated services that are customized to subscriber's preferences and apply policy decisions dynamically to respond to changing network and subscriber status.

The policy manager 110 comprises a rules database 110a for storing policy regulations and a policy interface 110b to enable communication between the policy manager 110 and the access gateway 102 for the IP access network. The policy interface 110b is preferably implemented using Diameter, COPS, or RADIUS protocols. However, it will be appreciated that any suitable protocol may be employed.

As illustrated in FIG. 1, the policy manager 110 comprises a policy controller 110c. The policy controller 110c is arranged to receive triggered events from the online charging system 112 and the offline charging system 114. The policy controller is further arranged to acknowledge receipt of the triggered events to the online and offline charging systems.

In one embodiment, the triggered events received comprise information pertinent to policy regulations to be deployed for a specific subscriber. In particular, the policy controller 110c is arranged to generate a set of policies for a subscriber based on the information received from the online or offline charging systems and reconcile these with default policies determined from the subscriber profile, to produce a set of policy regulations for provisioning for the subscriber.

The online charging system 112 provides for session and event based charging and credit control for operator services.

The online charging system 112 comprises a trigger interface 112a for enabling the charging system 112 to trigger events to the policy controller 110c of the policy manager 110 and receive acknowledgements of the triggered events from the policy controller 110c. In one embodiment, the trigger interface 112a is implemented using a Telco grade low latency protocol such as Diameter.

In another embodiment, the events triggered by the online charging trigger interface 112a are spend notification messages, which may comprise a subscriber identifier, (e.g. IMSI, MSISDN, Username, Subscription ID), a list of spend counter values, a list of spend counter changes/trigger actions, a subscriber spend lifecycle state, and/or a subscriber spend lifecycle change.

The online charging system 112 also comprises a charging interface 112b to enable communication between the charging system and access gateway 102, network or service node 106. The charging interface 112b may be implemented using a transactional charging specific protocol such as Diameter Credit Control Application, RADIUS, Web Services or Parlay protocols. However, it will be appreciated that any suitable protocol may be employed.

The online charging system 112 comprises a rating device 112d and balance manager 112e for enabling transaction management, rating and account balance management of subscriber balances.

In one embodiment, the rating device 112d is provided for determination of a price or tariff specific to one or more correlated chargeable events or scenarios. Examples of such scenarios include one or more of the following:
i. Per unit rating: rate determined based on the number/amount of units for example seconds, minutes, bytes, kilobytes, etc.
ii. Set up rating: rate determined using a flat set up fee for the service.
iii. Tiered rating: rate determined on per unit basis where the per unit rate changes as successive thresholds levels are crossed.
iv. Tapered rating: rate determined where rate charged per unit reduces as the total number of unit increases.
v. Allowance rating: rate determined where first X units are free/fixed fee and the remainder are charged a different rate (overage rate).
vi. Time band rating: rate determined according to time of day, day of week, holiday or promotion day.
vii. Domain banding: rate determined per subscriber or subscriber group rating device.

In one embodiment, the balance manager 112e provides account balancing functions including:
viii. Flexible Account Hierarchy
   1. Flexible account types (single, family, corporate, etc.) with associated subscribers.
   2. One or more purses associated with an account.
   3. Balances associated with each purse.
   4. Ability to make reservations against balances.
ix. Account Lifecycle Management
   1. Defines and manages lifecycle states for accounts
x. Balance Monitoring
   1. Monitor balance and refill activity and trigger actions as appropriate.
xi. Account Balance Manipulation
   1. Check account balances
   2. Account balance updates
   3. Account balance reservations
   4. Check validity and expiry dates

The online charging system 112 further comprises a spend manager 112c which includes a spend counter for monitoring account information or spend data associated with each subscriber. In one embodiment, the spend data is based on criteria such as total spend of the year, month, week, or day to date, total spend of the day, total spend, spend per billing cycle and spend per cycle. The spend counter is also configured to apply spend rollover once specific rules or criteria are satisfied.

The spend manager 112c is further arranged to track a history of a subscriber and to this end, maintains a life cycle for each subscriber, storing state and state transitions for a subscriber during the lifetime of their relationship with the network. This information can be utilized to make decisions with regards to the policy regulations to be provisioned under different situations. For example, a subscriber with a history of timely payments may be afforded a grace period for payment of an overdue account prior to degrading of their policy regulations.

In response to a spend counter of a subscriber exceeding certain thresholds, the spend manager 112c is configured to take action. For example, such action may be the triggering of an event across the trigger interface 112a, or the recording of a transition in the spend lifecycle associated with the subscriber.

In one embodiment, the spend manager 112c is configured to perform aggregation and correlation across groups of subscribers such that amalgamated spending can be monitored and managed. For example, such groups may be organized by one or more of the following attributes, account ID (family, corporate, government), location, market, demographic (for example, age), and account or plan type.

Similarly to the online charging system, the offline charging system 114 comprises a trigger interface 114a for enabling the offline charging system 114 to trigger events, which may be spend notification messages, to the policy manager 110 and receive acknowledgements of the triggered events from the policy manager 110. In one embodiment, the trigger interface 114a is implemented using a Telco grade low latency protocol such as Diameter or other suitable protocol.

An offline charging interface 114b is provided to enable communication between the charging system and operator services once a session has been completed. The offline charging interface 114b may be implemented using FTP, FTAM, Diameter Accounting, RADIUS, IPDR, Web Services or Parlay protocols. However, it will be appreciated that any suitable protocol may be employed.

The offline charging system 114 further comprises a rating device 114d and a spend manager 114c, which correspond with and provide the same functionality as, the rating device 112d and a spend manager 112c, respectively, of the online charging system 112.

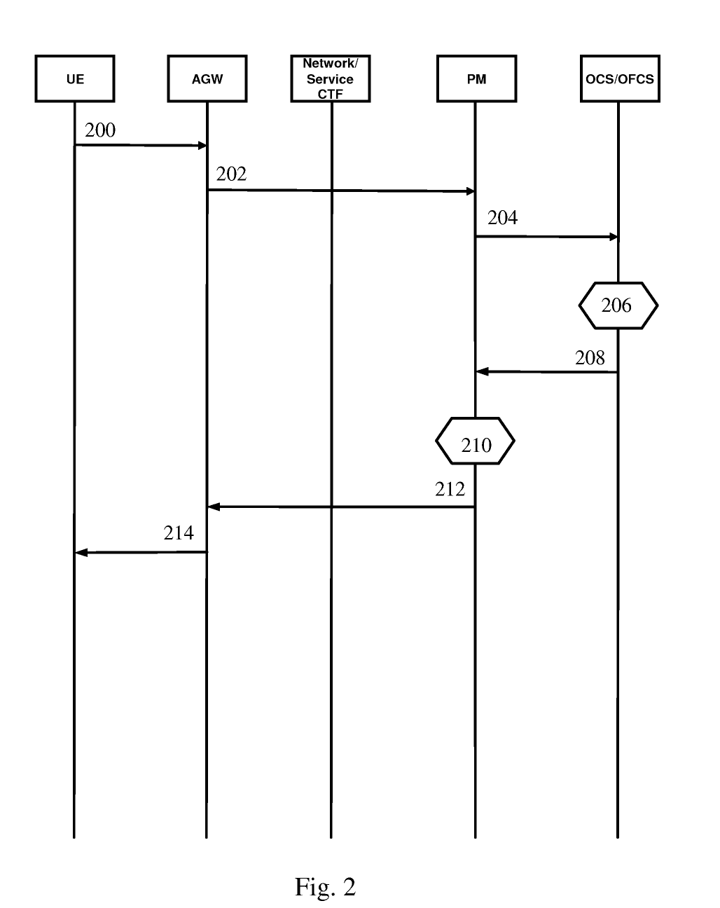

Referring now to FIG. 2, there is illustrated an access gateway initiated message flow for spend policy initialization.

A user at a terminal employs IP enabled user equipment (UE) to connect to the network by sending 200 a connect request to the access gateway (AGW) 102. In one embodiment, the connect request comprises information identifying the subscriber associated with the user terminal, and a destination network to which the user wishes to connect.

The access gateway (AGW) 102 processes the request and requests 202 policy regulations for the subscriber associated with the terminal from the policy manager (PM) 110.

The policy manager (PM) 110 queries a subscriber profile associated with the user equipment to determine default policy and charging regulations for the subscriber. In one embodiment, the subscriber profile is stored in the database 116.

The policy controller 110c of the policy manager (PM) 110 sends 204 a request to the online charging system (OCS) 112 for updated subscriber related information, and in particular, charging information.

The online charging system (OCS) 112 determines 206 the subscriber related information which is then provided 208 to the policy controller 110c.

The policy controller 110c generates a set of spend related policies based on the subscriber related information received and reconciles these with the default policies determined from the subscriber profile.

The policy manager (PM) 110 composes 210 policy and charging regulations for the subscriber based on the reconciled policies.

The policy manager (PM) 110 supplies 212 the subscriber's policy and charging regulations to the access gateway (AGW) 202. The access gateway 102 subsequently sends 214 a response to the user's request.

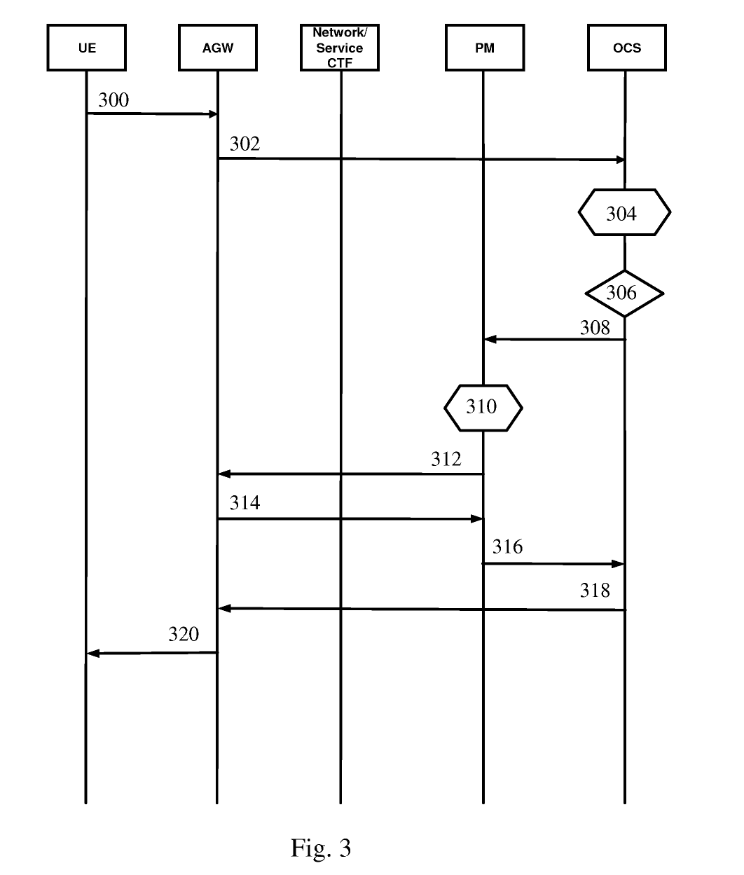

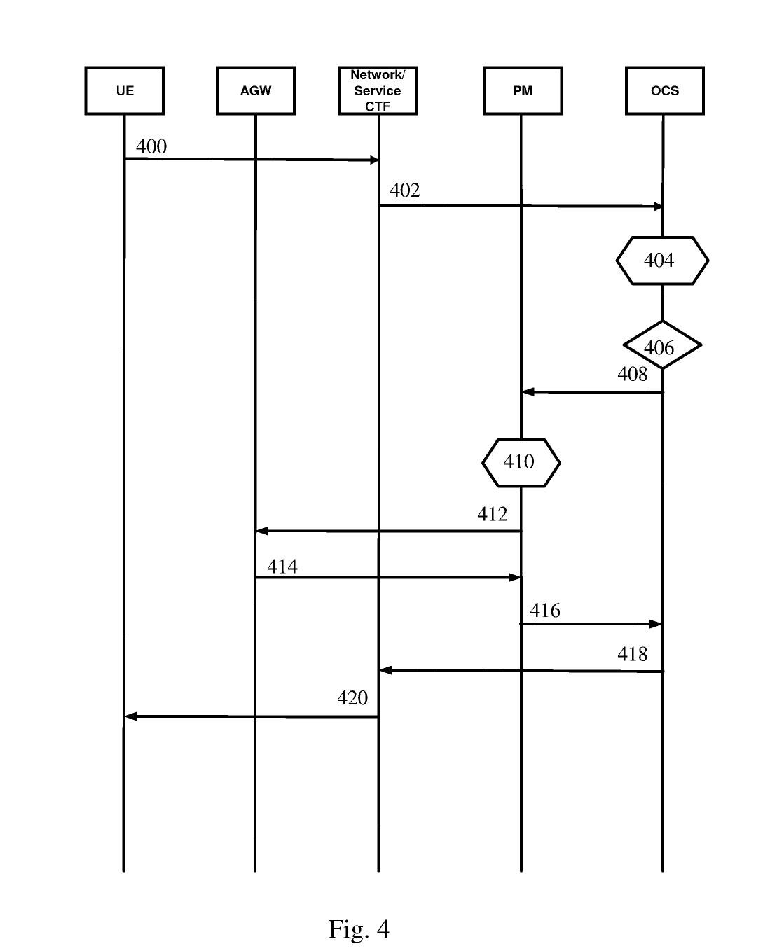

Referring now to FIG. 3 and FIG. 4, there is illustrated a spend trigger notification message flow for a gateway controlled online charged subscriber, and a spend trigger notification message flow for a network/service node controlled online charged subscriber, respectively.

The user at the terminal employs IP enabled user equipment (UE) to send 300, 400, to request a service, for example, 3GPP (GERAN/UTRAN/E-UTRAN EPC), 3GPP2, DOCSIS, or WiMAX.

The access gateway (AGW) or a network/service node processes the service delivery request and requests 302, 402, service authorization for the subscriber from the online charging system (OCS). In one embodiment, the service authorization request comprises information identifying the subscriber associated with the user terminal and service requested.

The online charging system (OCS) calculates 304, 404, the cost of the service requested, and queries account information associated with the subscriber to determine whether the subscriber has sufficient credit, either prepaid or contractual, to meet the cost of the service. A subscriber spend counter, and in some embodiments the subscriber's lifecycle is updated to reflect the purchase.

If the spend counter exceeds 306, 406, a spend threshold, an event is triggered 308, 408 via the trigger interface 112a of the online charging system (OCS) to the policy manager (PM) 110. In one embodiment, the triggered event comprises subscriber information and an indication of the updated policy regulations to be provisioned.

The policy controller 110c of the policy manager (PM) 110 recalculates 310, 410, the policy regulations associated with the subscriber based on the subscriber information received from the online charging system (OCS) 112.

The policy manager (PM) 110 performs 312, 412, a reauthorization request to the access gateway (AGW) 102. The access gateway (AGW) 102 processes the reauthorization of the subscribers policy regulations and acknowledges 314, 414, receipt to the policy manager (PM) 110.

The policy manager (PM) 110 acknowledges 316, 416, the triggered event to the trigger interface 112a of the online charging system (OCS) 112, and the online charging system (OCS) 112 subsequently sends authorization 318, 418, to the access gateway 102, or network/service node 104 and the user is informed 320, 420 accordingly.

An example of such a situation may occur where a user is streaming a video to his device. The spend manager 112c in the online charging system 112 monitoring the subscriber's spend associated with the user determines that a spend threshold has been exceeded and in response, triggers an event to the policy manager 110 indicating that the subscriber should be reauthorized with updated policy regulations, for example, increasing the subscriber's bandwidth allowance, to thereby allow the subscriber to view the remainder of the video in High Definition. The policy manager 110 takes the necessary actions, and the user is informed accordingly.

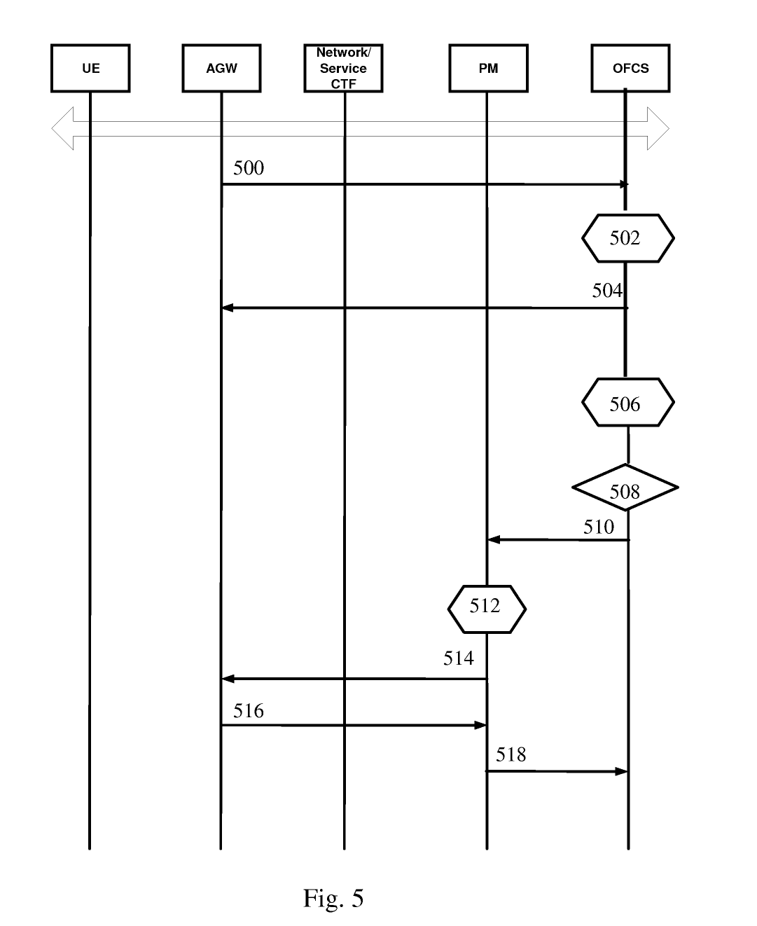

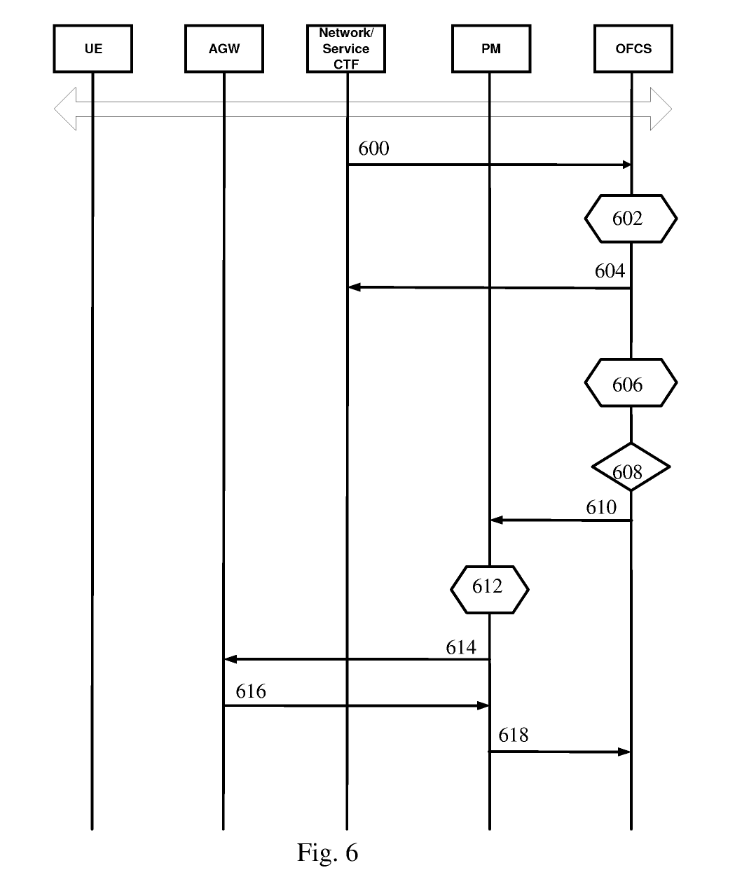

Referring now to FIG. 5 and FIG. 6, there is illustrated a spend trigger notification message flow for a gateway sourced offline charged subscriber, and a spend trigger notification message flow for a network/service node sourced offline charged subscriber, respectively.

Once a service, for example, 3GPP (GERAN/UTRAN/E-UTRAN EPC), 3GPP2, TISPAN, DOCSIS, or WiMAX, has successfully been provided to a user at the terminal (UE), the access gateway (AGW) 102 or network/service node 104, generates and sends 500, 600, an accounting termination request to the offline charging system (OFCS) 114.

The offline charging system (OFCS) 114 terminates 502, 602, an accounting/call detail record for the service delivered to the subscriber and acknowledges 504, 506, to the policy manager (PM) 110 receipt of the request.

The offline charging system (OFCS) 114 calculates the cost of the service delivered to the subscriber and a subscriber spend counter, and in one embodiment, a subscriber lifecycle, is updated 506, 606, accordingly.

If the spend counter exceeds 508, 608, a spend threshold, an event is triggered 510, 512 via the trigger interface 112a of the online charging system (OCS) to the policy manager (PM) 110. In one embodiment, the triggered event comprises subscriber information and an indication of the updated policy regulations to be provisioned.

In one embodiment, the policy controller 110c of the policy manager (PM) 110 recalculates 512, 612, the policy regulations associated with the subscriber based on the subscriber information received from the online charging system (OCS) 112 and these are stored in the subscriber's profile as the current applicable policy regulations for a subscriber.

However, in an alternative embodiment the database 116 is populated with the received subscriber information, enabling the policy manager 110 to retrieve and recalculate the policy regulations associated with the subscriber based on the stored subscriber information, during a subsequent session.

The policy manager (PM) 110 performs 514, 614, a reauthorization request to the access gateway (AGW) 102. The access gateway (AGW) 102 processes the reauthorization of the subscribers policy regulations and acknowledges 516, 616, receipt to the policy manager (PM) 110.

The policy manager (PM) 110 acknowledges 518, 618, the triggered event to the trigger interface 112a of the online charging system (OCS) 112.

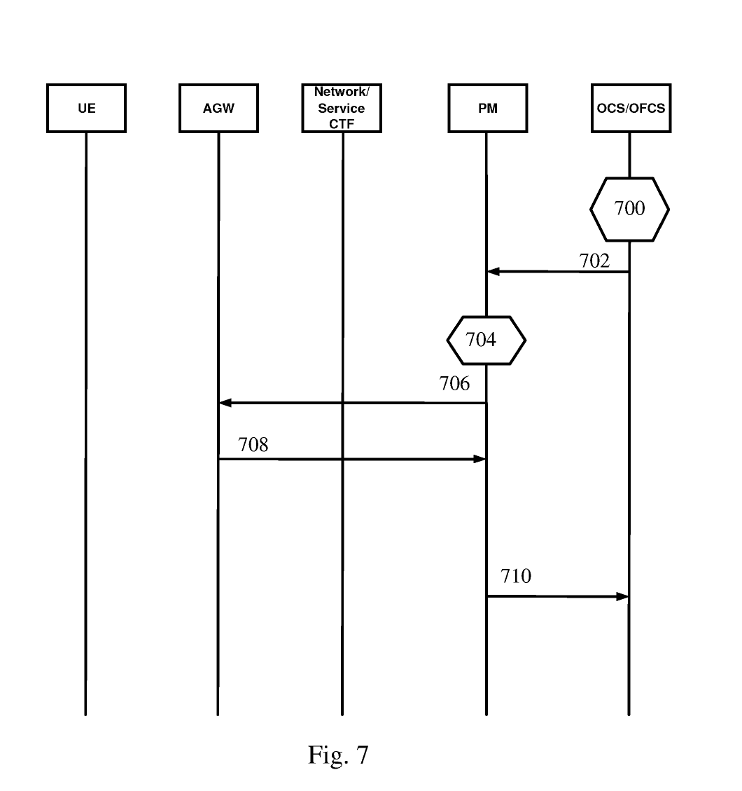

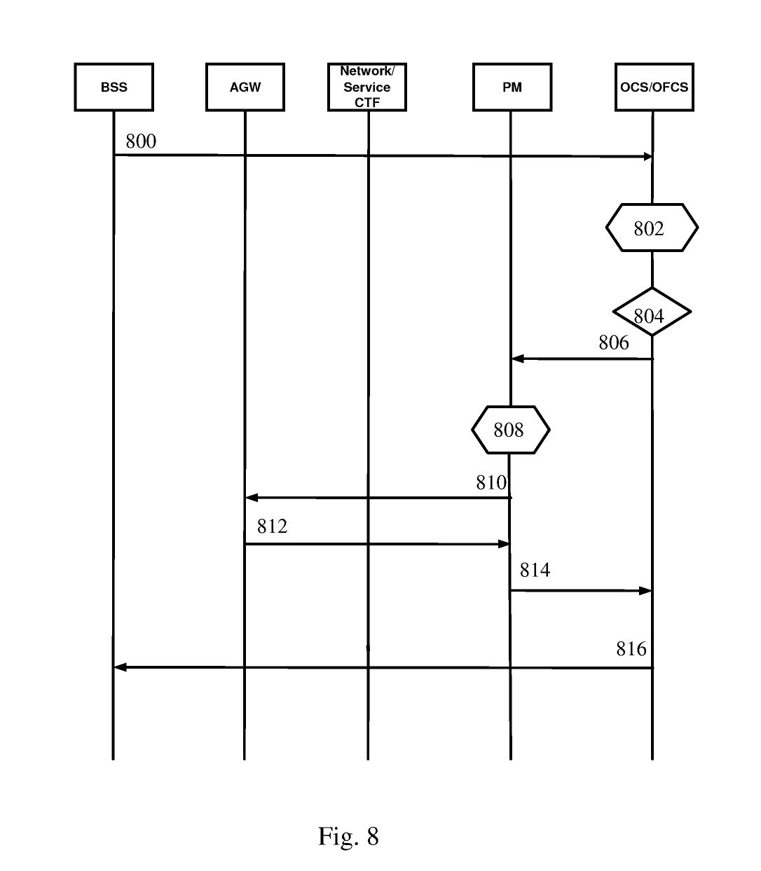

Referring now to FIG. 7 and FIG. 8, there is illustrated session independent spend trigger notification, instigated 700 by a logical device provided in the charging system 112, 114, or instigated 800 by a spend notification received from an independent party 106, such as a business support system, respectively.

In the case that a spend notification is received from an independent source as depicted in the message flow of FIG. 8, the online or offline charging system (OCS) calculates 802, the cost of the service requested, and queries account information associated with the subscriber to determine whether the subscriber has sufficient credit, either prepaid or contractual, to meet the cost of the service. A subscriber spend counter is updated to reflect the purchase.

If the spend counter exceeds 804, a spend threshold, an event is triggered 806 via the trigger interface 112a of the online or offline charging system (OCS) to the policy manager (PM) 110. In one embodiment, the triggered event comprises subscriber information and an indication of the updated policy regulations to be provisioned.

In the case of a logical device being provided in the online or offline charging system 112, 114, once it is determined that a subscriber spend counter exceeds a spend threshold, an event is triggered 702 via the trigger interface 112a of the online or offline charging system (OCS) to the policy manager (PM) 110.

In both cases as depicted in FIG. 7 and FIG. 8, once the event is triggered to the policy manager (PM) 110, the policy controller 110c of the policy manager (PM) 110 recalculates 704, 808, the policy regulations associated with the subscriber based on the subscriber information received from the online or offline charging system (OCS) 112, 114.

The policy manager (PM) 110 performs 706, 810, a reauthorization request to the access gateway (AGW) 102. The access gateway (AGW) 102 processes the reauthorization of the subscribers policy regulations and acknowledges 708, 812, receipt to the policy manager (PM) 110.

The policy manager (PM) 110 acknowledges 710, 814, the triggered event to the trigger interface 112a, 114a, of the online or offline charging system (OCS) 112, 114.

In the case depicted in FIG. 8, the online or offline charging system (OCS) 112, 114 subsequently acknowledges 816 to the business support systems domain 106, the spend notification received.

An example of instigation of a trigger by a logical device in the online or offline charging system 112, 114, involves the spend manager 112c, 114c, identifying that a subscriber typically associated with a high spend, now has a spend which falls short of a low value threshold. In response, the spend manager 112c, 114c, triggers an event to the policy manager 110 indicating that the subscriber's policy regulations should be updated to provision the user with a premium service, for example, in order to entice the user from switching networks, and the user is informed accordingly.

Another example of a trigger by a logical device in the online or offline charging system 112, 114, involves the charging system determining that a prepaid subscriber's account has a zero balance. The spend manager 112c, 114c, identifies the subscriber as an important customer and triggers an event to the policy manager 110 indicating that the subscriber should be temporarily provisioned with post-paid policy regulations, to thereby provide the subscriber with sufficient time to ‘top-up’ their account balance, and the user is informed accordingly. Once the subscriber has ‘topped-up’, or once the grace period has expired, the spend manager 112c, 114c, triggers an event to the policy manager 110 indicating that the subscriber should once again be provisioned with prepay policy regulations.

In yet another example of a trigger by a logical device in the online or offline charging system 112, 114, the spend manager 112c, 114c, notices that a subscriber's spend is approaching a threshold and triggers an event to the policy manager 110 indicating that the subscriber should be temporarily provisioned upgraded policy regulations, and the user is informed accordingly. If the subscriber's spend has not exceeded the threshold after a specified period of time, the spend manager 112c, 114c, triggers an event to the policy manager 110 indicating that the subscriber's upgraded policy regulations should be revoked.

An example of instigation of a trigger received at the online or offline charging system 112, 114, from a third party, may occur where a user is roaming, and thereby connects to a visited network. The network recognizes the user as a previous user and supplies this information to the online or offline charging system 112. The spend manager 112c, 114c, triggers an event to the policy manager to instruct the user's policy regulations to be provisioned at certain treatment level, for example, equivalent to the policy regulations provisioned by their home subscriber in order to reward the user for their loyalty.

Another example of instigation of a trigger received at the online or offline charging system 112, 114, from a third party, involves, receiving an indication from a customer service management system that a subscriber's balance should be credited to appease a disgruntled customer, for example. If the spend manager 112c, 114c determines that the subscriber's spend then exceeds a threshold, or alternatively if instructed directly by customer service, the spend manager 112c, 114c, triggers an event to the policy manager 110 indicating that the subscriber's policy regulations should be upgraded and the user is informed accordingly.

An alternative scenario triggering the spend manager 12c, 114c to instruct the policy manager to upgrade a subscriber's policy regulations involves the subscriber's spend being increased by a user ‘topping up’ or settling their account, and in one embodiment, topping up’ or settling their account by a larger amount than normal, causing the spend manager to increase beyond a threshold.

The present disclosure is not limited to the embodiment(s) described herein but can be amended or modified without departing from the scope of the present embodiments.

1. A computer implemented method of policy control of a telecommunication service to a subscriber of the telecommunication service, the method operable in a communications network comprising a policy manager in communication with a charging system, the method comprising the steps of:
at the charging system,
determining spend information specific to the subscriber; and
responsive to a stimulus, communicating the spend information to the policy manager;
at the policy manager,
obtaining policy rules associated with the subscriber;
responsive to obtaining the spend information from the charging system, composing policy regulations based on the policy rules and the spend information;
provisioning the policy regulations to the subscriber.

2. The method according to claim 1 further comprising at said charging system monitoring a spend counter maintaining account information associated with each subscriber and activating said stimulus in response to a threshold value being met by said spend counter.

3. The method according to claim 2 wherein said account information comprises spend data criterion including at least one of total spend per year to date, total spend per month to date, total spend per week to date, total spend per day to date, total spend, spend per billing cycle, and spend per cycle.

4. The method according to claim 1 further comprising at said charging system activating said stimulus in response to a triggered event from one of an access gateway, a subscriber at a terminal, a customer service management system, a business support system and a network or service node.

5. The method according to claim 2 further comprising at said charging system responsive to a change in the state of a spend counter, updating an entry in a lifecycle representation of a history of activities of associated with the subscriber over a period of time.

6. The method according to claim 1 wherein said spend information comprises at least one of a subscriber identifier, a list of spend counter values, a list of spend counter changes, a subscriber spend lifecycle state and a subscriber spend lifecycle change.

7. The method according to claim 1 wherein said step of obtaining policy rules associated with the subscriber comprises determining said policy rules from a profile of said subscriber stored in a database connected to said policy manager.

8. The method according to claim 1 wherein said step of obtaining policy rules associated with the subscriber comprises reconciling default policy rules with preferences obtained from a profile of said subscriber stored in a database connected to said policy manager.

9. The method according to claim 8 wherein said profile comprises subscriber policy directives including at least one of: tariff name plan, roaming preferences, network preferences, content filtering, charging class, quality of service attributes, permitted services, and online charging control.

10. The method according to claim 1 further comprising at the charging system determining a tariff associated with the subscriber based on at least one charging option including per unit rating, set-up rating, tiered rating, tapered rating, allowance rating, time band rating and domain rating.

11. The method according to claim 2 wherein said threshold is a high spend threshold and said spend information comprises an indication to said policy manager to upgrade the policy regulations provisioned to the subscriber.

12. The method of claim 11 wherein said upgrade comprises improving subscriber policy directives including at least one of tariff name plan, roaming preferences, network preferences, content filtering, charging class, quality of service attributes, permitted services, and online charging control.

13. The method according to claim 2 wherein said threshold is a low spend threshold and said spend information comprises an indication to said policy manager to degrade the policy regulations provisioned to the subscriber.

14. The method of claim 10 wherein said upgrade comprises degrading subscriber policy directives including at least one of tariff name plan, roaming preferences, network preferences, content filtering, charging class, quality of service attributes, permitted services, and online charging control.

15. The method according to claim 2 further comprising responsive to a low spend threshold being exceeded, and responsive to determining that said subscriber is a priority customer, including an indication to upgrade the policy regulations provisioned to the subscriber in the spend information to be communicated to the policy manager.

16. The method of claim 15 wherein said priority customers include high spend customers, regular customers, pre-paying customers, good credit history customers, and disgruntled customers.

17. The method of claim 1 further comprising updating said policy rules associated with the subscriber based on the composed policy regulations.

18. The method of claim 18 further comprising storing said updated policy rules in a rules database provided in the policy manager.

19. A computer program product comprising a computer readable medium storing and recording instructions in machine readable form which when executed in a computer implemented policy control system provided in a communications network are effective to cause a computer implemented policy control system to carry out the steps of claim 1.

20. A computer implemented policy control system for providing policy control to a subscriber of a telecommunication service, the policy control system comprising a charging system in communication with a policy manager across a network,
the charging system comprising:
a balance manager for determining spend information specific to the subscriber; and
a spend manager responsive to a stimulus, for communicating the spend information to the policy manager; and
the policy manager comprising:
a policy controller for obtaining policy rules associated with the subscriber; and responsive to obtaining the spend information from the charging system, composing policy regulations based on the policy rules and the spend information; and provisioning the policy regulations to the subscriber.

21. A computer implemented method for policy control in a communications network, the method comprising the steps of:
at a charging system,
responsive to a stimulus, triggering a subscriber specific event to a policy manager;
at the policy manager,
responsive to receipt of the subscriber specific event, composing policy regulations for said subscriber based on information associated with the received event.
